(19) United States
(12) Patent Application Publication
(10) Pub. No.: US 2012/0310679 A1
(43) Pub. Date: Dec. 6, 2012

(54) METHOD AND APPARATUS FOR INSURING AGAINST CROP LOSSES

(76) Inventors: Kent Dana Olson, Ottawa, IL (US); Bruce John Sherrick, Champaign, IL (US); Gary Donald Schnitkey, Dewey, IL (US)

(21) Appl. No.: 13/487,875

(22) Filed: Jun. 4, 2012

Related U.S. Application Data
(60) Provisional application No. 61/493,126, filed on Jun. 3, 2011.

(51) Int. Cl. G06Q 40/08

(52) U.S. Cl. 705/4

(57) ABSTRACT

A method and apparatus for insuring farm crops against low crop yields includes insuring a farm enterprise gains low crop yields averaged across the farm enterprise. The farm enterprise being insured against a crop yield below a first percentage of historical crop yields for the farm enterprise. The farm enterprise also being insured against a low crop yield for crop units, such as fields, wherein the crop unit is insured against a crop yield below a second percentage of historical crop yields for each insured crop unit. An insured loss occurs if the average yield for the farm is below the first percentage. An insured loss also occurs if the yield of one or more farm units is below the second percentage even if the average yield for the farm is above the first percentage.

### CROSS-REFERENCE TO RELATED APPLICATION

This application claims the benefit of U.S. Provisional Patent Application Ser. No. 61/493,126, filed Jun. 3, 2011, which is incorporated herein by reference.

### BACKGROUND OF THE INVENTION

1. Field of the Invention

The present invention relates generally to a method for insuring against crop losses for farmers, and to an apparatus used in insuring against crop losses.

2. Description of the Related Art

Commercial farming operations seek to raise one or more farm crops with the expectation of income from the sale of the crops. Factors outside the control of the farmer, such as excessive rainfall or lack thereof; heat or cold (including frost), damaging winds, hail, flooding, insects, diseases, etc. impact the yield from the crops and thus the income of the farmer.

Farm crop yield insurance is offered to farm owners and farm operators to insure against lower than expected crop yields. The Federal Crop Insurance Corporation (FCIC) was established under the U.S. Department of Agriculture as a government program to permit farmers to insure against crop losses. The Risk Management Agency was established under the U.S. Department of Agriculture to administer the FCIC programs. Private sector participation in the crop insurance program was authorized along side the government program. The FCIC encourages the sale of crop insurance through licensed private agents and brokers.

Crop insurance is a contractual agreement between an insured farmer and an insurance provider. The farmer insures eligible crop land, typically being limited to crop land in a particular county of a state and for a particular crop. The insurance provider agrees to indemnify the farmer against losses that occur during the crop year that are the result of unavoidable perils beyond the farmer's control. Multiple peril crop insurance covers losses from a several different factors, whereas a single peril policy may cover only damage that is a result of only one factor, such as hail damage, for example.

The range of insurable crops under the farm insurance program has expanded to more than 100 different crops.

Insurance policies are commonly offered on an enterprise basis. Each farm enterprise is covered for a particular crop yield, for example, as a percentage of the historical yield from the farm. If the crop yield for the farm falls below the percentage specified in the insurance policy, a covered loss has occurred and the farmer will be paid as compensation for the loss. However, a low yield for a particular field or portion of the farm may be offset by higher yields from other fields or portions of the farm enterprise, resulting in a total yield for the farm enterprise that is higher than the percentage under the crop insurance so that no payment is made to the farmer for the loss.

A crop insurance policy may be obtained on smaller units rather than extending to the yield of the entire farm enterprise. However, the risks that a particular field, for example, may experience a low crop yield is considerably higher than risks spread across a farm enterprise. The result is that while individual units of farmland are insurable, the premium for such policies can be quite high and may not be economically feasible.

### SUMMARY OF THE INVENTION

The present invention provides a method for insuring against reduced crop yield by offering to farmers a crop insurance policy that has a two or more levels of coverage. In a first level established by the policy, the farm enterprise is insured against reduced crop yield, or crop losses, to a first production percentage at an enterprise-wide level. Crop yields are averaged across the whole farm enterprise and, if the yield falls below the first production percentage of the historical crop yield, an insured loss has occurred and results in a payment under the policy. In a second level established by the policy, individual units of the farm—for example farm fields—are insured at a second, lower percentage of historical crop yield. If the farm enterprise wide crop yield is above the first percentage set by the first level, yet the crop yield of one or more insured individual farm units falls below the second percentage level, an insured loss has occurred and a payment is made under the policy, even if the loss would not have resulted in a payment under the enterprise-wide portion of the policy.

The method according to the principles of the present invention may be embodied in software operating on a computer device wherein a processor of the computer device executes steps of the method under control of the software. The software as well as data, such as historical crop yield data, on computer readable memory devices that can be accessed by the computer and the processor. An apparatus according to the present invention is also provided.

Optional features of the method and apparatus offer policies on optional units as divisions within basic units of farmland. Alternative embodiments of the present method and apparautus offer crop loss policies that protect crop yield to a particular yield level, that protect farm revenue to a particular revenue level, or that protect farm revenue with one or more predetermined exclusions (such as harvest price exclusions).

A further embodiment calculates and displays to a customer or potential customer the predicted possible payments that may be made under the crop insurance policy at a plurality of different crop prices and at a plurality of different coverage levels based on percentages of historical yield. The predicted possible payments include payment amounts for enterprise-wide average crop yields that fall below insured yield levels for the farm enterprise and payment amounts for farm unit crop yields that fall below insured yield levels for farm units of the farm. The predicted possible payments may be calculated from actual yield data of the farm or enterprise of the customer or from similar farms or enterprises.

Yet another embodiment provides calculates and displays to an insurance agent and others the premiums to be charged for insuring the farm or enterprise at at least one enterprise-wide percentage and at least one farm unit percentage. The premium calculations may be based on calculated potential losses. Preferably, the calculation determines premiums at a plurality of enterprise-wide percentages and a plurality of farm unit percentages. The agent can thereby quote prices for premium payments for the customer.

A further embodiment provides a regional analysis based on historical yield data of regions or counties and presents information on financial aspects of two tiered, or two level, insurance policies that may be offered to farmers within the regions or counties.

### BRIEF DESCRIPTION OF THE DRAWINGS

FIG. 1 is a schematic block diagram showing a relationship between an insurer and a farm enterprise for the crop insurance policy, the farm enterprise including units according to the principles of the present invention;

FIG. 2 is a schematic diagram showing the relationship between an enterprise unit, basic units and optional units according to an alternative embodiment of the present method, illustrating an example of unit structure;

FIG. 3 is a block flow diagram showing a sequence of steps performed in the method for offering an a combination policy to an insured;

FIG. 4 is a block flow diagram showing a sequence of steps performed in the method showing a premium quoting approach for the combination policy;

FIG. 5 is a block flow diagram showing a sequence of steps performed in the method showing a payment process under the combination policy;

FIG. 6 is a schematic diagram showing an example of a computer system for performing the steps of the present invention;

FIG. 7 is a block flow diagram of analysis software according to the present invention;

FIG. 8 is a block flow diagram of quoting software according to the present invention.

### DETAILED DESCRIPTION OF THE PREFERRED EMBODIMENTS

In FIG. 1, a farming enterprise 10 is made up of a number of farm units or basic units 12. For example, the farm units 12 may be different fields or parcels of land within a single larger farm operation. The units or parcels 12 may grow different crops or the same crop and may have different conditions impacting the risks of growing crops on each unit. For example, one basic unit or field may be more prone to flooding than another field or unit on the farm. The farm may have different operations on different units, such as growing corn or soybeans, grazing cattle for milking, feed operations for fattening cattle, etc. The farm units 12 may be individual farms within a larger collective farm operation. The units 12 may be fields and/or farms in different counties or different states. Other definitions of basic units 12 are also possible within the scope of the present invention.

The term enterprise or farm enterprise 10 similarly may take a range of definitions, including a single farm within which are basic units 12, a collective farm or larger commercial operation made up of individual farms and/or parcels, or a large farming business unit overseeing operations at different farms and/or farm collectives. Other definitions of enterprise are likewise possible.

The farmer or landowner, who may also be referred to as the producer, wishes to purchase a crop yield insurance policy to insure against crop yields below a particular level. For purposes of the present method and apparatus, the farmer or producer may also be referred to as the policy holder or as the insured. The term “insured” may cover a producer who has purchased the policy and also covers a potential purchaser of the policy. The producer or farmer of the farm enterprise 10 requests a crop policy 14 from an insurer 16 to insure against crop losses. The insurer 16 may be backed by a federal agency 18 in offering the policy 14. The insurer 16 collects production history information from the enterprise to determine a historical crop yield for the enterprise 10 as well as for the various basic units 12 within the enterprise. The historical yield, also referred to as the actual production history or APH, is an average of production for past years. Preferably, an average of yields for at least four consecutive years, and possibly yields for up to ten consecutive years, is obtained for the historical yield determination. It is possible that limited historical yields for the particular crop land or for the particular crop may result in reduced data available for the historical determination. The limited data that is available may be used or estimates may be made based on comparable crop land, for example.

The enterprise level may cover one crop grown within a single county of a state, according to one embodiment of the insurance policy. In one example of an enterprise set out in further detail below, the historical average yield of the enterprise has been determined to be 160 bushels of the particular crop per acre. Other measures of production are of course possible, and may depend on the type of insured farming activity.

A percentage of the historical yield is chosen for coverage. The percentage may be chosen by the producer or the insurer may instead offer a single percentage of coverage or may offer the producer a range of coverage levels from which to choose. In one embodiment of the policy, the insurer offers coverage levels of between 50% and 85% of the historical yield in 5% increments. In other words, the producer may chose a policy to insure against losses of 50% of the AHP, 55% of AHP, 60% of AHP, and so on up to 85% of AHP. Higher coverage levels increase the guarantee, increasing the chance that the producer will receive an insurance payment and, if a loss occurs, increasing the amount of the insurance payment. The premiums for the higher coverage policies are thus generally higher.

In the example, the producer selects a coverage level of 85% of the historical yield which will trigger a claim under the policy. For the farm enterprise having a 160 bushel per acre APH (actual production history) the trigger is 136 bushels (160 APH×85% coverage level). Enterprise-wide production below 136 bushels per acre for the insured crop season can be claimed as a loss under the policy, resulting in a payment to compensate the enterprise 10 for the loss. A yield less than the coverage level will result in the producer being paid the bushel shortfall times the relevant price.

The crop yields from various units within the enterprise may vary. Even if a unit within the enterprise has a yield that falls below the coverage percentage, other units within the enterprise may have yields sufficiently high that the combined value or average value for the yield of the enterprise is above the coverage percentage and therefore does not trigger a claim under the policy. For this reason, insuring the enterprise level is less expensive, i.e. requires the payment of lower insurance premiums, than if the units were insured individually at the coverage level. Coverage of crop loss at the enterprise level may be referred to as an enterprise policy.

The enterprise 10 has an option according to the present method to purchase an add-on to the enterprise policy. The add-on extends coverage to units 12 within the enterprise. In the preferred embodiment, the coverage percentage for the units 12 is lower than the coverage percentage for the enterprise. In other words, a greater crop loss must be experienced to trigger a claim under the unit coverage portion of the policy. A policy that offers crop loss protection at both the enterprise level as well as at the farm unit level may be referred to as an enterprise plus policy.

In the example in which the producer has chosen an 85% coverage level for the enterprise, the producer in the example chooses a 75% coverage level for the unit portion of the policy. The enterprise of the example has three 80 acre units that are eligible for coverage. Each unit has an average historical production of 160 bushels per acre. It is of course possible that each unit would have different historical production levels. At the 75% coverage level, a claim is triggered at a production of 127.5 bushels per acre for the insured unit. For the insured growing season in the example, the three 80 acre units of the enterprise have produced crop yields of 115, 136, and 160 bushels per acre, respectively. The average of the three units is 137 bushels per acre so that the producer would not be paid on the enterprise coverage, which as noted above is triggered by an enterprise-wide average production below 136 bushels. The unit coverage is, however, triggered for the unit with the 115 bushel yield, since this falls below the 127.5 bushel threshold in the unit level coverage. The claim for loss is based on the difference between insured threshold and the actual yield (127.5−115=12.5 bushels). This would generate a payment for the bushel shortfall (12.5 bushels per acre×80 acres for the unit=1000 bushels), and the bushel shortfall is multiplied by the relevant price of the crop to obtain the dollar amount of the payment. The relevant price of the crop is preferably determined as set forth in the policy. The payment to the farmer in the example is only for the single 80 acres farm unit that experienced a crop production level or loss below the coverage amount and does not extend to the other units within the enterprise.

Thus, the example provides yield (YP) insurance to the producer to insure against losses as a result of yields below the coverage level at either the enterprise level or the unit level. The producer is able to ensure against crop losses at the unit level within the enterprise while still receiving the benefit of more attractive premiums, subsidies and other considerations as a result of the coverage at the enterprise level. The total premiums for the combined enterprise level and unit level policy (enterprise plus coverage) of a preferred embodiment are lower than if the individual units were insured individually even at the lower coverage level.

Instead of basing the loss on crop yield, it is also possible that the crop insurance policy insures a monetary return of a particular value, also referred to as revenue protection (RP) insurance. The details on the revenue protection policy are much the same as those on the crop yield policy except that the revenue realized by the sale of the crops is the determining trigger for a covered loss, as will be understood by those of skill in the art. The revenue protection (RP) policy thus extends the protection to variations in crop price in addition to variations in crop yield.

The number of subunits 12 or 22 that may be covered within one enterprise 10 or 20 can vary depending on a variety of factors. It is envisioned that a limit on the number of possible subunits 12 or 22 under one enterprise be placed on policies issued according to the present invention. In one example, the number of subunits 12 or 22 for an enterprise 10 or 20 is limited to seven, while in another example the subunit limits for an enterprise is ten. Other limits are of course possible, or the policy may be offered without limits on the number of subunits.

In some embodiments, the policy holder may elect an option under the policy to receive the higher of the payment under the enterprise-wide coverage or the payment under the subunit coverage, where both levels are triggered. This may require the payment of the maximum of the payments under the enterprise policy or the sum of the individual insured sub-units in the cases where both the enterprise and sub-unit limits are triggered. The policy holder may be required to pay a higher premium for this coverage option. When this option is not offered, the policy provides that when a loss has occurred under one coverage situation, for example, a loss under the enterprise-wide coverage, a payment for a loss under the other coverage, for example unit coverage, is not available.

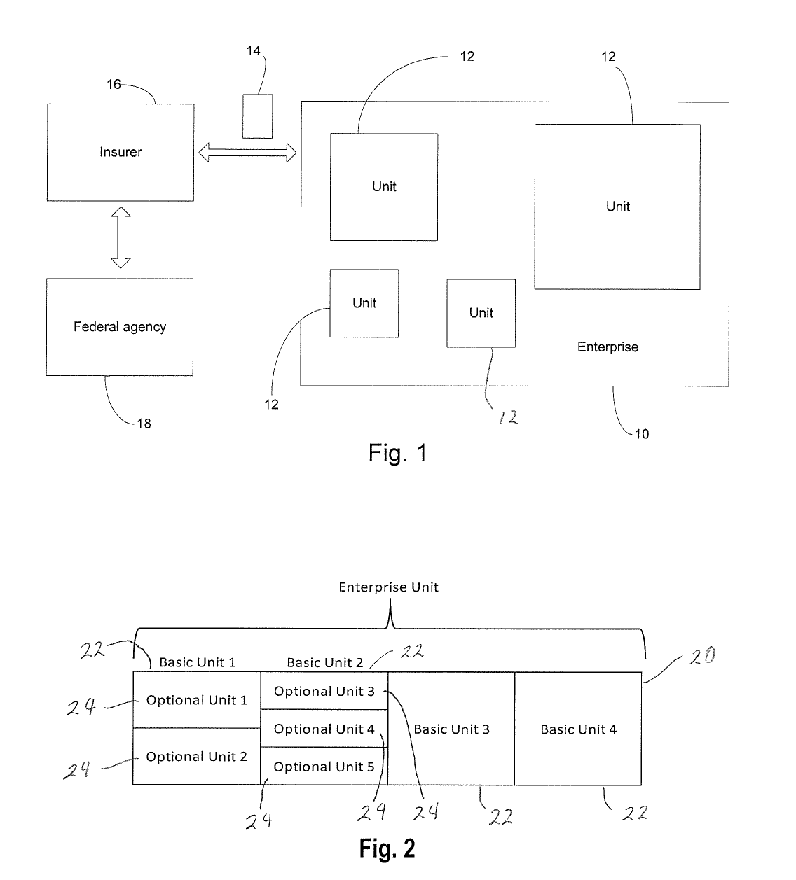

An alternative embodiment is provided according to the present method as shown in FIG. 2. In this embodiment, the coverage is offered at unit structure that includes three different unit levels: the enterprise unit level 20, the basic unit level 22, and an optional unit level 24. The enterprise units 20 include all farm units dedicated to one crop in a county of a state. Basic units 22 include farm units that have a smaller number of acres and include all of one crop in a county as defined by ownership split. One basic unit 24 includes all owned and cash-rent farmland, and one basic unit 24 is assigned for each share-rent landlord. Optional units 24 are divisions of basic units 22. A basic unit 22 could have optional units 24 if the acres of farm land in the basic unit 22 are in different township sections of the county, for example. FIG. 2 shows an example of an enterprise unit 20 that has four basic units 22. The basic unit labeled basic unit 1 in the FIG. 2 has two optional units 24 and the basis unit labeled basic unit 2 has three optional units 24. The basic units 3 and 4 cannot be divided into optional units. The descriptions herein of policies with two levels of coverage can include three levels of coverage as desired.

Farmers and landowners can use any of the above three units or divisions when insuring through federally-insured crop insurance products or policies according to the present invention. The insurance according to the present method is made available to the farm owner through COMBO insurance policy product that may include a Yield Protection (YP) coverage plan, a Revenue Protection with Exclusion (RPwExl) coverage plan, and a Revenue Protection (RP) coverage plan. Yield protection measures the farm output in yield production units, such as bushels of crop yield per acre. Revenue protection measures include coverage for variations in crop price to ensure that the farmer receives at least an insured level of revenue from the crop. Variations on this provide exclusions in the revenue protection plan. An alternative policy provision calls for revenue protection or yield protection with harvest price exclusion (RPHPE). These coverage types may be available at the enterprise-wide level, and may be available at the sub-unit level as well.

If enterprise units 10 or 20 are covered in the policy, there will be one guarantee level offered by the policy for the enterprise-wide coverage. In calculating the enterprise-wide guarantee an Actual Production History (APH) yield for the enterprise is used. Except in cases of limited historical yields, the APH yield is an average of at least four consecutive yield years and possibly up to ten consecutive yield years from the insured farm unit. After the growing season is completed, the actual yield from the enterprise unit 10 or 20 is used in determining if the crop insurance guarantee under the policy for the enterprise is met. If the policy also includes coverage for the basic units 12 or 22, the policy will provide one guarantee for each basic unit, with an APH yield for each unit. Yields from each basic unit then will be used in determining if their respective guarantees are met. Similarly, there will be one guarantee for each optional unit 24 if optional units are used to insure yields. Yield from each optional unit 24 then will be used to see if that unit's guarantee is met.

For the same coverage level in the same year, optional units 24 may have higher insurance payments than basic units 22. Basic units 22 may have higher insurance payments than enterprise units 20. However, optional units 24 may have higher premiums than basic units 22 and basic units 22 may have higher premiums than enterprise units 20 because of higher payment amounts. Moreover, federal subsidies may be higher for enterprise units 20 than from basic 22 and optional units 24.

When choosing federally subsidized crop insurance, an insured, or producer, may have to make three choices that have impacts on policy choice. The first choice is the unit level at which the crop insurance will be offered (i.e., enterprise level, basic level, and optional units level). Second, the insured may determine under which type of crop insurance will purchased (yield protection—YP, revenue protection with exclusion—RPwExl, and revenue protection—RP). Third, the insured may make a coverage level choice, i.e. the percentage of historical yield that triggers a covered loss. In one embodiment, insureds can choose coverage levels between 50 and 85 percent of historical production in five percent increments. Higher coverage levels increase the guarantee, thereby increasing the chance of the insured receiving an insurance payment and, when the payments occur, the amount of the insurance payments. Conversely, the lower coverage levels reduce the chance of an insured loss and the amount of the insurance payment when a loss occurs. As such, the premiums may be higher for higher coverage levels and lower at lower coverage levels.

The yield protection and revenue protection (in all its variations) options are available for enterprise level policy and sub-unit level policy protections.

Under the present method, a farmer and landowner will take one of the plans within the COMBO product or policy at a coverage level at the enterprise unit level. Then, an Enterprise Plus product or policy can be purchased that will use the same plan as under the COMBO product but will provide coverage at basic, optional, or other sub-enterprise unit structure. Basic, optional, or other sub-enterprise units hereafter will be referred to as sub-units. The insured will be able to choose a different coverage level under enterprise plus portion of the policy than was chosen under the COMBO product. The insured will be required to pay a premium for crop insurance policy and provide APH yield data for the enterprise covered under the policy. The insured may also have to provide actual yields from each sub-unit under the policy. It is envisioned that data for nearby farms or farms in similar conditions may be used to fill in missing historical production data for the sub-units as well as for the enterprise. The insurer may make a payment to the insured if the COMBO product does not trigger a payment for the enterprise and but the coverage for the sub-units based on actual yields and guarantees from the basic or optional units indicate that a payment should be made to the insured under the enterprise plus portion of the policy.

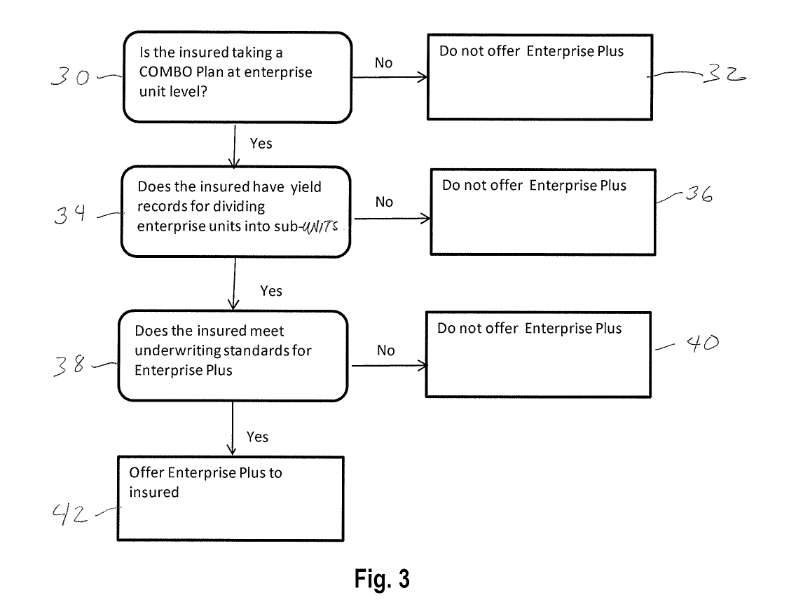

To be eligible for the policy add-on to cover the sub-units, the insured must purchase the COMBO product or policy at the enterprise unit level. See step 30 of FIG. 3 wherein a determination is made, for example by the insurance seller or agent, as to whether the insured is purchasing the enterprise-wide coverage. If the insured does not purchase enterprise-wide coverage, then the enterprise plus coverage for sub-unit level protection is not offered, as seen in step 32. The insured must also be able to provide APH yields for each of the sub-units to be covered, as shown at step 34. If not, the insured is not offered the sub-unit coverage, also termed enterprise plus, as shown in step 36. To make a claim for a loss under the policy, the insured must also be able to provide data on this year's actual yields from all insured sub-units for the insured crop season. This may require the farmer to segregate yield from the different insured fields or take other measures to provide the required data. Finally, the insured must be able to meet underwriting standards to be offered Enterprise Plus for the unit level coverage, as shown in step 38. If the underwriter standards are not met, the producer or insured is not offered the sub-unit coverage as shown at step 40. If these conditions are met, the policy add-on can be offered to the insured as shown at step 42. The farmer or insured purchases a crop loss policy that has a level of coverage at the enterprise level and a level of coverage at the sub-unit level according to the present method and apparatus. The determinations made in the illustrated steps may be made at various levels in the insurer organization and all determinations need not be made at the same level, or the determinations may even be made by the farmer to determine whether the sub-unit coverage can be purchased.

Some or all of the steps set forth in FIG. 3 may be performed using a computer device and/or computer communication system. For example, the yield records of step 34 maybe communicated and stored by a computer device. Further, the comparison of the potential insured's information to the underwriting standards may be performed by a computer device and/or computer communication system.

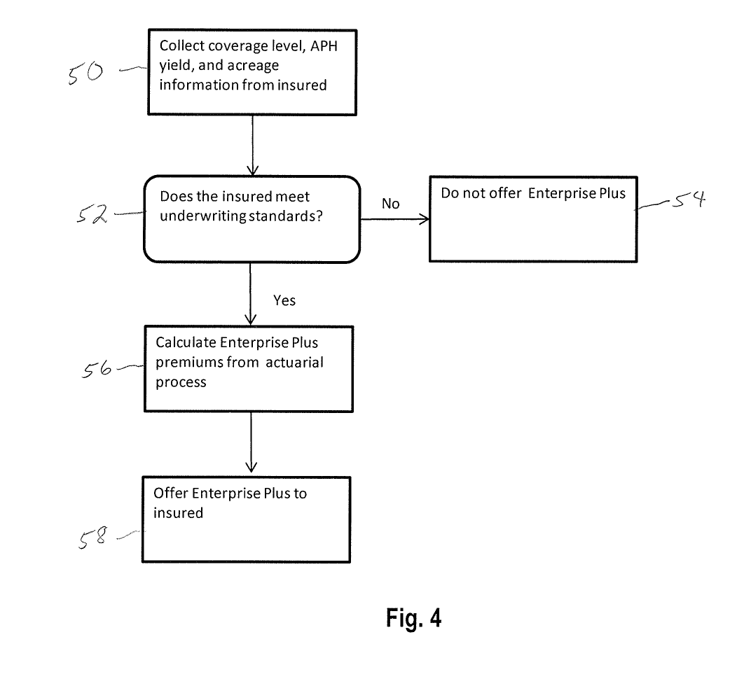

For eligible individuals (producers or farmers), rates for the policy add-on to cover sub-units within the enterprise then will be determined according to the flow chart of FIG. 4. The insurer or agent at step 50 collects information on the coverage level desired, the historical crop yields and the acreage to be insured from the insured (or potential insured). This may require collecting the COMBO product plan selected, the coverage level of the enterprise unit, the desired level of the policy, and APH yields from the enterprise and sub-units. Under step 52, this information will again be used to determine if the insured meets underwriting standards. If not, the sub-unit coverage is not offered, at step 54. The information will also be placed in an actuarial process using a simulation engine to develop rates for the potential insured as shown at step 56. Once the premiums or rates have been calculated, the policy is offered to the insured at step 58.

The steps of FIG. 4 may be performed by a computer device and/or computer communication system. For example, the collection of the coverage level information, the historical yield data and the acreage information is preferably performed by a computer device and stored on computer readable media that is accessible to the computer device. The comparison of the potential insured's information to the underwriting standards of step 52 may be performed by the computer device. The calculation of the premiums of step 56 is performed by the computer device.

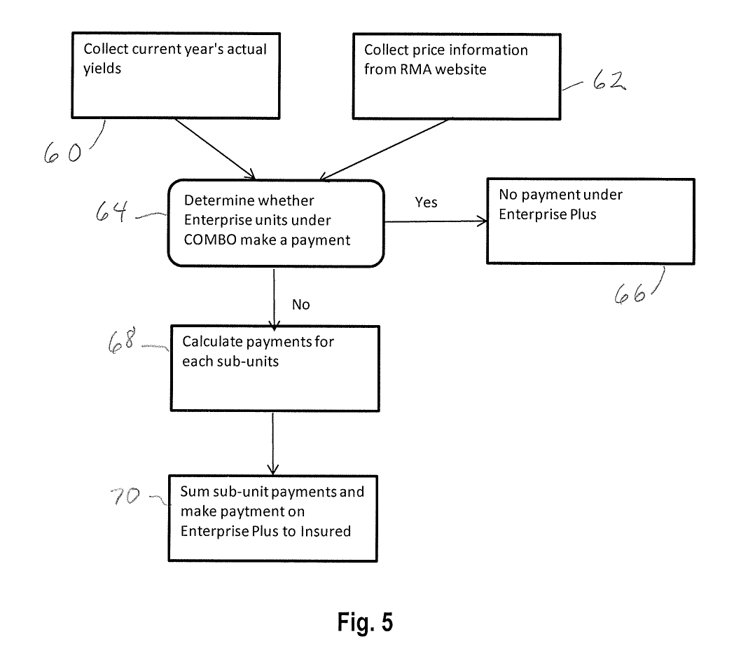

Turning to FIG. 5, after the harvest has taken place, it will be determined whether payments will be made under the policy. In step 60, information is collected by the insurer from the producer or insured on the actual yields of the crops for the each of the insured sub-units and for the enterprise. The farmer may have to keep separate records for each field or each portion of the farm covered under the policy to provide the information needed to determine whether payments will be made. Also, in step 62, projected price data and/or harvest price data will need to be collected for the determination, such as from the Risk Management Agency (RMA). One possible source of the price data is from the RMA website. In step 64, the collected data will be used to determine whether a payment for a loss is to be made to the insured under the COMBO product with enterprise units. In particular, the actual yield values averaged over the farm enterprise will be compared to the yield values specified in the policy to trigger an insured loss for the enterprise. If the policy type is based on yield protection, then actual yield values are compared to the policy yield values. As noted before, a payment for a loss may be calculated by multiplying the production shortfall by the relevant crop price. The relevant crop price may include projected prices for settlement of yield shortfalls. If the policy type is based on revenue, then actual revenue values are compared to policy revenue values to determine if a payment will be made. Any exclusions provided for in the policy are taken into account in the determination as well.

In the policy of this example, the triggering of a payment under the enterprise-wide level eliminates the possibility of a payment under the sub-unit level coverage. As such, a positive result in step 64 takes the flow to step 66 where no payment is made under the enterprise plus coverage at the sub-unit level. The insured may receive a payment for the enterprise-wide coverage. If the COMBO product does not make payments for the enterprise units, then in step 68 a calculation is performed for each of the insured sub-units. This may include a comparison of the guarantee levels for each of the basic and optional units to the actual yield levels for each unit. Insurance payments for each unit will be calculated. In step 70, the sum of payments across the insured units will be paid to the insured.

The steps of FIG. 5 may be performed by a computer device and/or using a computer communication system. For example, the collection of the yield and price data in steps 60 and 62 are performed by a computer. The determination of whether an enterprise payment is to be made and the calculation of the payments for the sub-units in steps 64 and 68 are also performed by the computer device. The payments to the insured under step 70 may even be performed by the computer device using the computer communication system.

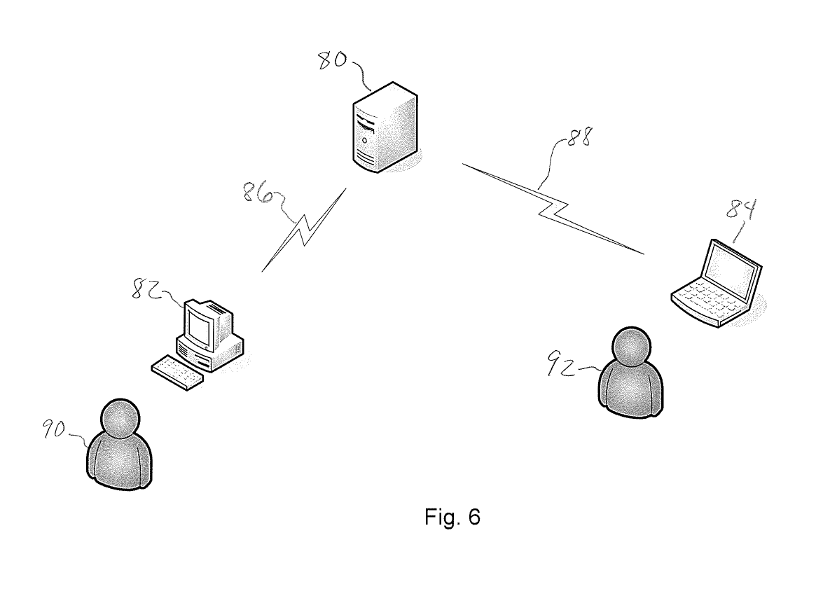

The method of the present invention is preferably performed by a machine, such as a computer system or a computer device, an example of which is shown in FIG. 6. Thus, the present invention also encompasses an apparatus. Data for determining the historical yield levels of the enterprise, the units and the sub-units may be collected and calculated using a computer system that may include a server 80 and user operated computers 82 and 84 connected to the server 80 via communication links 86 and 88, such as via wired and wireless networks, the Internet, or other communication means. For instance, a user 90 may input the data to the computer 82 from which it is uploaded to the server 80 for storage and processing. A second user 92 may upload data, or may download the data stored from the server 80, using the computer device 84 and otherwise interact with the computer device 84 as the computer 84 and/or server 80 perform steps of the method. The user 90 may be the potential insured who provides yield data or other information via the computer 82. The user 90 may instead be a sales agent, employee or other person acting on behalf of the insurer who interacts with the computer 82 as the computer 82 and/or the server 80 perform steps of the method. The server 80 may comprise a plurality of servers connected to a network, possibly including computer readable storage media linked to the network as well. The computer system and network may include a distributed in a plurality of locations, may be located at a single site or office, or may include cloud storage. The computer devices may include desktop computers, laptop computers, netbook or notebook computers, tablet computers, PDAs, smart phones, kiosks, workstations, or other computer devices. The computer devices have one or more processors for executing software that performs one or more of the steps of the present method.

The computer system may store crop yields, policy limits, and financial information and perform calculations for crop loss policies on farm enterprises and sub-units in a county, a portion of a state, an entire state, a region of the country, or even across the entire country. Policies according to one embodiment of the present method and apparatus may be offered in conjunction with state crop insurance programs in Illinois, Kentucky, Michigan, Nebraska, North Dakota, South Dakota and Kansas, as well as other states.

Data relating to the production for the insured crop season as well as historical yield data, as well as algorithms to perform the calculations to determine premium payments, to determine whether an insured loss is triggered, to determine the amount of the payout under the policy and for performing other calculations are stored on tangible, intransient computer readable media accessed via the computer system and executed by processors within the one or more computers of the computer system. Other configurations of computer systems are of course possible within the scope of the invention.

The server 80 and/or computer readable media accessible to the server may have stored thereon historical crop yield data from various crops within various counties and at different types of farm unit locations. The historical yield data may be used to calculate potential loss, premium amounts and other values used or potentially used in the present method and apparatus. Comparison of a potentially insured to other similarly situated farms may enable adjustments to be made in the policy limits, premiums or other factors.

An example of an algorithm utilized in the present method provides a simulation model. The simulation model relies on data from the Type-15 records to paramaterize both the yield distributions and correlations across units, and uses implied distributions from the underlying futures prices to represent the possible outcomes on individual units and the implied enterprise aggregate. The engine runs (roughly 80,000) scenarios to represent the correlated distributions and calculates the payments that would occur under the various unit options. The specific distributional items are similar to those in the iFarm model, and utilize some fairly well developed materials to detrend the yield distributions and characterize these using a method of moments analog to Weibull distributions. The price distribution is represented as a lognormal, but uses a proprietary (multidimensional, multi option) model that is analogous to inverting a set of Black-Sholes models simultaneously. The premium and projected prices are from RMA inputs. The model is developed in an Excel, Matlab, Visual Basic and @Risk platform, and tested across both FBFM and specifically determined case farms.

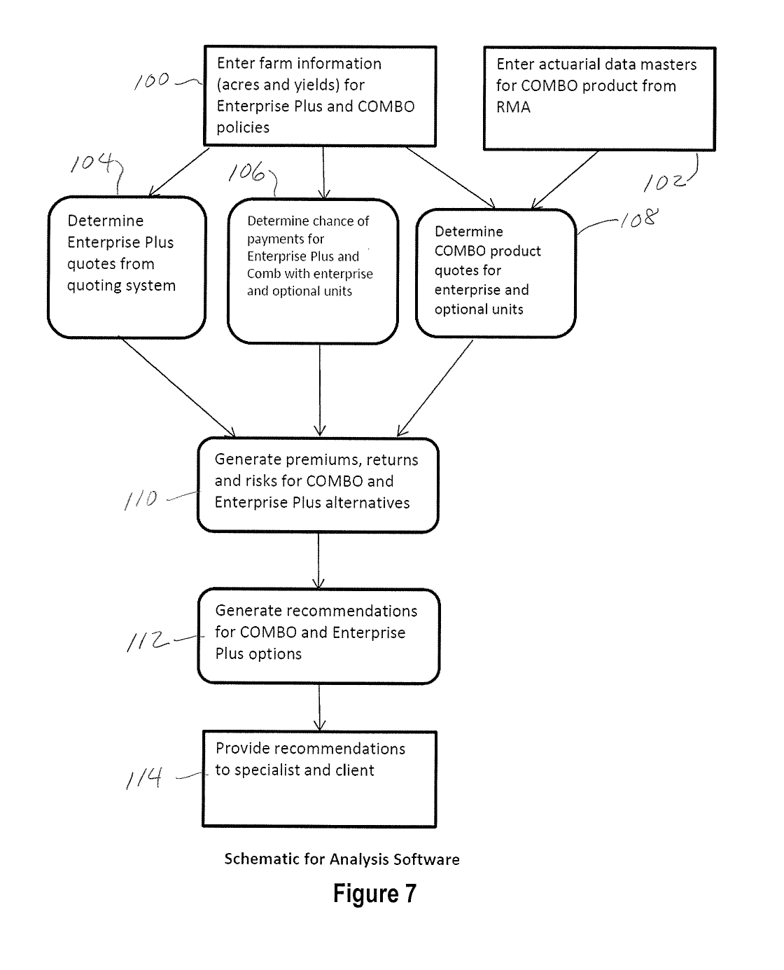

FIG. 7 provides analysis software or method for use in an embodiment of the present invention. The software of a preferred embodiment is executed by a computer system to perform the following steps. In step 100, farm information such as the size of the farm in acres and the historical yield information is entered for the enterprise-wide, or Combo, policy and the sub-unit, or enterprise plus, policy. In step 102, the actuarial data masters for the enterprise-wide or Combo policy is entered from the RMA. In step 104, input is received from step 100 and a determination is made using a quoting system (to determine the price to be quoted for the premiums) of the quote to the potential insured for the sub-unit coverage under enterprise plus. Step 106 also receives an input from the step 100 and determines the chance that a payment might be made for a loss under the policy that includes enterprise coverage as well as sub-unit coverage under enterprise plus. The optional units as shown in FIG. 2 may also be included in the calculation. Step 108 determines the quotes to be provided to the potential insured for the Combo policy or product at an enterprise level, as well as for coverage of optional units.

The outputs of the steps 104, 106 and 108 are combined in step 110 where the premiums, the returns and the risks are generated for the Combo enterprise policy with the enterprise plus sub-unit add-on policy. The premiums, returns and risks may be calculated for different levels of coverage, for example as percentages of historical yields, so that the potential insured may choose a desired coverage level. The calculations may determine that some combinations or options are too risky or present too low of an opportunity for a return and so these may not be offered to the potential insured. See step 112.

Step 112 generates recommendations for the enterprise and sub-unit level policy options. The recommendations may be based on potential return, potential risk, pricing considerations, location of the potentially insured fields or farms, or various other factors.

In step 114, the recommendations are provided to a specialist, such as an insurance agent, and to the potential insured or client. The recommendations may be provided via a computer device.

The method and software of FIG. 7 may be referred to as a “what-if” tool that demonstrates different combinations of prices and yields that trigger payments or that do not trigger payments. The software may be integrated with other software components of the system for use by sales personnel or others to simulate different circumstances. In a preferred embodiment, the method and software outputs a visual representation of the price and yield combinations and their effects on payments under the policy at different limit levels. The what-if scenarios are provided or shown to the farmer or potential insured as a schedule of combinations of yields and prices that generate payments in conjunction with the offer of insurance. The boundaries between cases that generate payments and those that do not become clear to the potential insured as well as to the seller or agent.

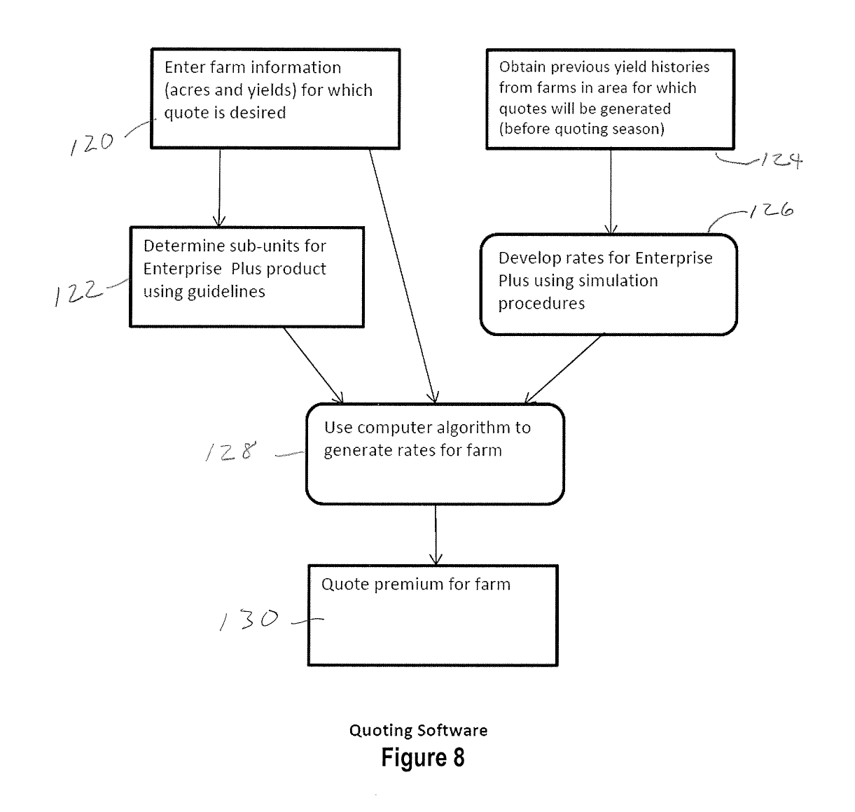

FIG. 8 shows steps performed by quoting software as used in the present method. In step 120, the farm information for which a premium quote is desired is entered, for example, into the computer system. The farm information may include the acreage and crop yield information. The step 120 output is provided to step 122 where a determination is made for the sub-units of the enterprise plus policy using guidelines. The guidelines may be derived from information on similarly situated farms or nearby farms or one other information.

In step 124, the yield histories are obtained for farms in the area of the farm for which the quote is being generated. The yield histories of nearby farms include yields from those farms from prior growing seasons. In step 126, a simulation is run to simulate one or more likely outcomes and thereby develop rates for the sub-unit level coverage.

The outputs of steps 120, 122 and 126 are provided to step 128 wherein a computer algorithm executed by the computer system calculates the premium rates for the farm. The premium rates may be offered as a menu of possible premiums for different levels of coverage. At the conclusion of the algorithm operations, the premium rates are provided, or quoted, to the farm, in step 130.

The output of this or other software according to the present invention may include the option of generating the insurance contracts that embody the terms and limits for the crop loss coverage. Although a single integrated contract may be provided, it is envisioned to provide different integration and different contract terms for each different insurance carrier and/or for each locality in which the policies are offered. The present software and method may be provided as a stand-alone component or may be integrated within a larger system offering other policies and products from an insurance carrier. One preferred embodiment integrates the policy documents for the crop insurance into a document requiring a single signature covering the enterprise and enterprise plus components as well as any other insurance components desired by the insured.

### Quoting System:

The enterprise plus quoting system involves a set of spreadsheet applications that convert a producer's yield production and acreage histories into the variables and parameters used in determining the pricing of the coverage provided under the terms of the Enterprise Plus insurance. The producer's historic production, yield, acreage, and record type information for each sub unit comprising the Enterprise are used to establish both the coverage parameters for the Enterprise Plus insurance, and the pricing case. The data can be typed in or converted from electronic data server processes. The quoting system allows individual historic APH databases (individual units) to be combined into the indemnified subunits. The quoting system can be described in terms of data entry, unit assembly, parameterization, and development of the variables used in quoting the coverage.

### Data Entry

The data entry is further delineated into common and unit level production history information. The common information includes the State, County, Crop, Insurance year, and information to identify customer and the contact information from the sales system. This information is used to establish relevant circumstances for the insurance including the FCIC insurance related information for trend adjustment, and underlying policy information.

In the form demonstrated, up to 14 individual APH database sets are entered in blocks with production, acreage, and yield type histories for a period of up to 20 years, though the number of units and length of history are flexibly determined. The yield record type is used to establish both eligibility and combination protocols. If no units are combined, then the individual units simply pass through to the following stage. If the number of subunits is more than the maximum allowed, then they are combined according to underwriting guidelines to form indemnified units that may differ from the RMA unit/database records. Eligibility criteria can be applied to screen data for uninsurable cases, or to generate the need for individually custom quoted outcomes.

### Unit Assembly

Assume that 14 sets of underlying units are available for a period of 10 years and that the units are all comprised of subunits with either actual or added land record types. The utility allows a user to “join” individual records and form combined units for indemnification by identifying the unit records to combine with a common code, in this case identified by letters A-G. The utility creates a weighted average of actual yields and a set of production analogs for the combined units that are individually indemnified. Differential treatment by record types is accomplished at this stage. The result is a set of historically combined yield, acreage, and type records that represent the features of the insured subunit, constructed from the individual APH databases and decisions on unit combinations.

### Parameterization

Methods for estimating the parameters of the insurance components are developed using related RMA databases, minimum allowable estimates of variance and APH on a trend adjusted basis using a proprietary algorithm related to RMA's adjustment and a county and acreage based acreage to variance relationship. A credibility related feature limits the variability estimates to values reflecting appropriate actuarial cases and prevents sample features from being converted to overly simplistic sample-only distributions from actual yield records. For example, the unit variability measures are treated as the maximum of the possible records estimated from either own records, or RMA county-based acreage corrected estimates of variance. The correlation set is also developed at this point for comparison to the meta-data generated in the actuarial cost estimator.

### Variables Transferred to Quoter

Where common, the data entered in the production entry sheet is directly transferred to the price quoting system based on the actuarial cost estimator. Examples include state, county, crop, unit design (acreage and production). Additionally, case values for selecting unit lines, correlation cases, and variance measures are converted to the form used in the cost estimator.

### Quoter

The Quoter takes the outputs from the production sheet along with the additional decisions for coverage levels from the Enterprise and underlying units, and generates the loaded and potentially “bucketed” indicative quote. The loadings and bucketing decisions are reflected in sections that would not be considered user-accessible.

### Prospect Evaluation Utility

The relative attractiveness of the enterprise plus policy depends on both the producer's production features and personal attributes, as well as the underlying ratings of the analog products from RMA. Because the underlying rates and subsidy structures for the underlying Enterprise and Optional Units differ dramatically by location and APH history, an evaluation system is developed to help identify the producer cases that would be expected to find this product to be most attractive.

The RMA Enterprise and Optional Unit rates differ by location, and the effective subsidy values differ more directly by location and coverage election. In general, Enterprise subsidy rates are substantially higher than optional unit subsidy rates at similar coverage levels. Underlying rate differences between the rates for an optional and an enterprise policy in a given location form a proxy for the estimate of the different total cost of insurance.

For concreteness, a stylized version of these items is provided in the following discussion. Suppose a farmer with three identical optional units with APH=180 is in a county where the optional unit coverage total premium is $100/acre and the Enterprise policy total premium is $60/acre. The difference can be viewed as an estimate of the actual cost of the difference in insurance of the individual optional units compared to the enterprise. Further, assume that the coverage level subsidy structure is as follows:

| Coverage | Optional | Enterprise |
|---|---|---|
| 70% | 0.59 | 0.8 |
| 75% | 0.55 | 0.77 |
| 80% | 0.48 | 0.68 |
| 85% | 0.38 | 0.53 |

In this case, the farmer-paid premiums for 80% coverage would be $52/acre (100*(1−0.48)) for optional unit coverage and $19.20/acre for enterprise ($60*(1−0.68)). The difference in subsidy rates is intended to encourage purchase of enterprise coverage. At a lower coverage level, the rates are lower, but the fraction of the coverage paid by the farmer is also greater. In the example, the 70% policies would cost $41 and $12 respectively. The underlying rates and differences in subsidy are of course designed to encourage purchase of enterprise insurance, and at higher coverages relative to their optional analogs. Importantly, the greater the difference in farmer-paid premiums, ceteris paribus, the more attractive the enterprise policy will be. The greater the total premium difference, the more available subsidy difference is available for transfer in coverage type or level, and the more valuable the additional coverage should appear, even if the underlying insurance features are identical. RMA allows only one type of policy to be purchased, and thus the differences in total cost and farmer paid premiums will result in different choices and willingness to pay for enterprise plus. For example, the actual difference between 85% coverage products (Enterprise minus Optional) is $36 in Mclean county, and $12.65 in Logan county for otherwise identical farms even though the difference in Enterprise total premiums is roughly $24 with Logan county being $76 (farmer paid $36) and Mclean at $52 (farmer paid $24). Enterprise plus at 85/75 has a total enterprise less optional farmer paid premium difference of $13.75 in Logan County and $2.75 in Mclean County for virtually identical farms.

The Prospect Evaluation utility is built on an RMA equivalent premium quoting system, and the difference in total premiums by coverage pair and farmer paid premiums by coverage pair calculated for each producer case. A standard case per county is designed for identification of the locations in which it would be expected that the RMA pricing structures would lead to most demand for the insurance provided under enterprise plus. The utility conveys the differences in farmer and total premiums for each available coverage pair and the differences in pairs by subsidy value to identify where the differences in the underlying programs convey the most attractive differential costs for the program.

Thus, there is provided a crop insurance “add-on” that allows crop insurance purchasers to buy federally subsidized crop insurance on enterprise units, but be eligible to receive payments based on individually eligible basic unit within the enterprise collective unit. The product responds to a commonly cited concern by producers that enterprise is more attractive based on premium, subsidy, and other considerations, but that they often have a sub-unit within the enterprise that would have paid if they had basic insurance on that unit.

The scope of the present method encompasses a policy that covers both enterprise coverage as well as coverage for any sub-units within the enterprise.

Alternative designs included in the method include different coverage level differentials, mechanisms for pricing the additional coverage, and ratings designs that allow assessment of the actuarial exposure under different designs. The calculation algorithms and associated machinery embed the premium calculations and rate subsidy differentials and producer records that determine unit level insurance exposure. It is envisioned that the producer expense will result in total premiums for the FCIC enterprise unit and additional coverage that are materially less than the cost of insuring all individual units at the lower coverage. Initial offerings will use the existing settlement process whenever the enterprise unit makes a payment, and the producer will not receive individual unit coverage even if payments exceed the blended enterprise payment. The adjustment process for individual unit claims will occur outside the payment system for FCIC supported products. All existing yield reporting requirements will remain.

Although other modifications and changes may be suggested by those skilled in the art, it is the intention of the inventors to embody within the patent warranted hereon all changes and modifications as reasonably and properly come within the scope of their contribution to the art.

We claim:

1. A method for insuring farm crops against low crop yield, comprising the steps of:
insuring a farm enterprise against crop yields for a predetermined crop below a first percentage of average historical yield, the insured crop yield being measured on an enterprise wide basis as an average of crop yield for the farm enterprise;
insuring at least one crop unit against a crop yield for the predetermined crop below a second percentage of average historical yield for the at least one crop unit, the second percentage being below the first percentage;
in a computer device, comparing an average crop yield for the predetermined crop for the farm enterprise to an average historical yield for predetermined crop for the farm enterprise to determine if the average crop yield falls below the first percentage, an average crop yield below the first percentage being a first insured loss;
paying the farmer for any first insured loss;
in a computer device, comparing a crop yield for the predetermined crop for the at least one crop unit to the average historical yield for the at least one crop unit to determine if the crop yield falls below the second percentage, a crop yield for the at least one crop unit below the second percentage being a second insured loss; and
paying the farmer for any second insured loss.

2. A method as claimed in claim 1, wherein said at least one crop unit is a field in the farm enterprise.

3. A method as claimed in claim 1, wherein said step of insuring at least one crop unit includes insuring a plurality of crop units, each of said plurality of crop units having a corresponding historical average yield.

4. A method as claimed in claim 3, wherein each of said plurality of crop units is insured at a same second percentage.

5. A method as claimed in claim 3, wherein ones of said plurality of crop units is insured as mutually different second percentages.

6. A method as claimed in claim 1, wherein said step of paying for a first insured loss includes the substeps of:
in a computer device, calculating a difference between average crop yield for the enterprise and the first percentage of average historical yield for the enterprise to determine a covered loss;
in a computer device, determining a market value of the covered loss for the enterprise; and
paying the farmer the market value of the covered loss for the enterprise.

7. A method as claimed in claim 1, wherein the step of paying for a second insured loss includes the substeps of:
in a computer device, calculating a difference between crop yield and the second percentage of historical yield of the at least one crop unit to determine a covered loss;
in a computer device, determining a market value of the covered loss for the at least one crop unit; and
paying the farmer the market value of the covered loss for the at least one crop unit.

8. A method as claimed in claim 1, further comprising the steps of:
estimating loss indemnifications for crop yields for a plurality of percentages of a historical yield for a farm enterprise;
calculating insurance premiums for the plurality of percentages of the historical yield for the farm enterprise;
insuring the farm enterprise at one of the plurality of percentages of the historical yield for the farm enterprise as the first percentage;
estimating loss indemnifications for crop yields for a plurality of percentages of a historical yield for the at least one crop unit;
calculating insurance premiums for the plurality of percentages of the historical yield for the at least one crop unit;
insuring the at least one crop unit at one of the plurality of percentages of the historical yield for the at least one crop unit as the second percentage.

9. A method as claimed in claim 8, further comprising the steps of:
in a computer device, calculating crop yields for a plurality of percentages of a historical yield for a farm enterprise;
in a computer device, calculating crop yields for a plurality of percentages of a historical yield for the at least one crop unit;
in a computer device, calculating a plurality of simulated loss indemnifications for the crop yields for the farm enterprise and for the at least one crop unit at a plurality crop prices and at the plurality of crop yields; and
displaying the simulated loss indemnifications at various crop prices and yields to a customer.
